(19) United States
(12) Patent Application Publication
(10) Pub. No.: US 2017/0274711 A1
(43) Pub. Date: Sep. 28, 2017

(54) Pressure Monitoring and Adjustment Device

(71) Applicant: Nathan Sowah, Oklahoma, OK (US)

(72) Inventor: Nathan Sowah, Oklahoma, OK (US)

(21) Appl. No.: 15/077,518

(22) Filed: Mar. 22, 2016

(51) Int. Cl. B60C 23/00; B60C 23/10; B60C 23/04

(52) U.S. Cl. CPC B60C 23/004; B60C 23/0408; B60C 23/041; B60C 23/0447; B60C 23/0423; B60C 23/0498; B60C 23/10

(57) ABSTRACT

A pressure monitoring and adjustment device for automated monitoring and adjustment of tire pressure includes a housing configured to couple to a rim of a wheel. A power module, a microprocessor, an air pump and a receiver are coupled to and positioned in the housing. The microprocessor is operationally coupled to the power module. The air pump and the receiver are operationally coupled to the microprocessor. The air pump has an outflow tube fluidically connected to a stem valve of the wheel. A sensor unit is coupled to the rim and positioned in the internal space defined by the rim and a tire mounted to the rim. The sensor unit is configured for wireless transmission of pressure measurements to the receiver. The microprocessor is positioned to respond to pressure readings relayed from the receiver to motivate the air pump to send air via the outflow tube through the stem valve.

### BACKGROUND OF THE DISCLOSURE

Field of the Disclosure

The disclosure relates to monitoring and adjustment devices and more particularly pertains to a new monitoring and adjustment device for automated monitoring and adjustment of tire pressure.

### SUMMARY OF THE DISCLOSURE

An embodiment of the disclosure meets the needs presented above by generally comprising a housing configured to couple to a rim of a wheel. A power module, a microprocessor, an air pump and a receiver are coupled to and positioned in the housing. The microprocessor is operationally coupled to the power module. The air pump and the receiver are operationally coupled to the microprocessor. The air pump has an outflow tube fluidically connected to a stem valve of the wheel. A sensor unit is coupled to the rim and positioned in the internal space defined by the rim and a tire mounted to the rim. The sensor unit is configured for wireless transmission of pressure measurements to the receiver. The microprocessor is positioned to respond to pressure readings relayed from the receiver to motivate the air pump to send air via the outflow tube through the stem valve.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a pressure monitoring and adjustment device according to an embodiment of the disclosure.

FIG. 2 is a front view of an embodiment of the disclosure.

FIG. 3 is a cross-sectional view of an embodiment of the disclosure.

FIG. 4 is a block diagram of an embodiment of the disclosure.

FIG. 5 is a schematic of an embodiment of the disclosure.

### DESCRIPTION OF THE PREFERRED EMBODIMENT

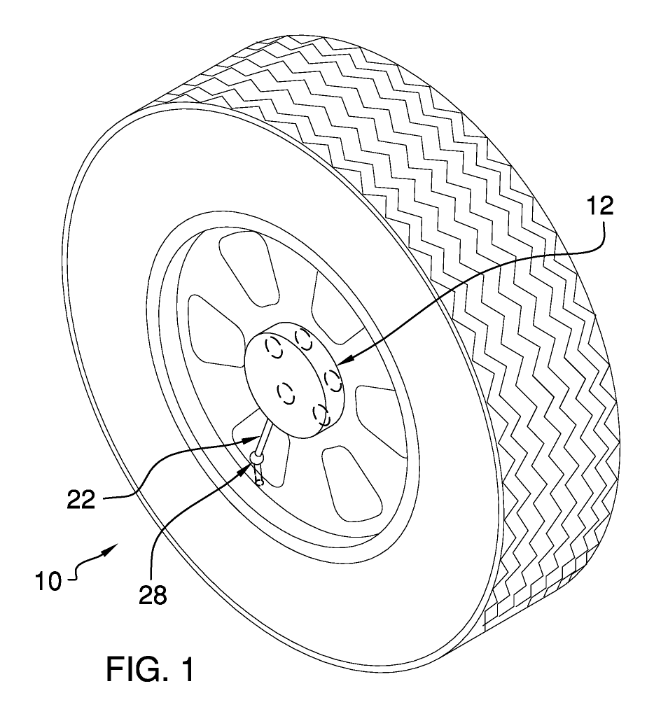

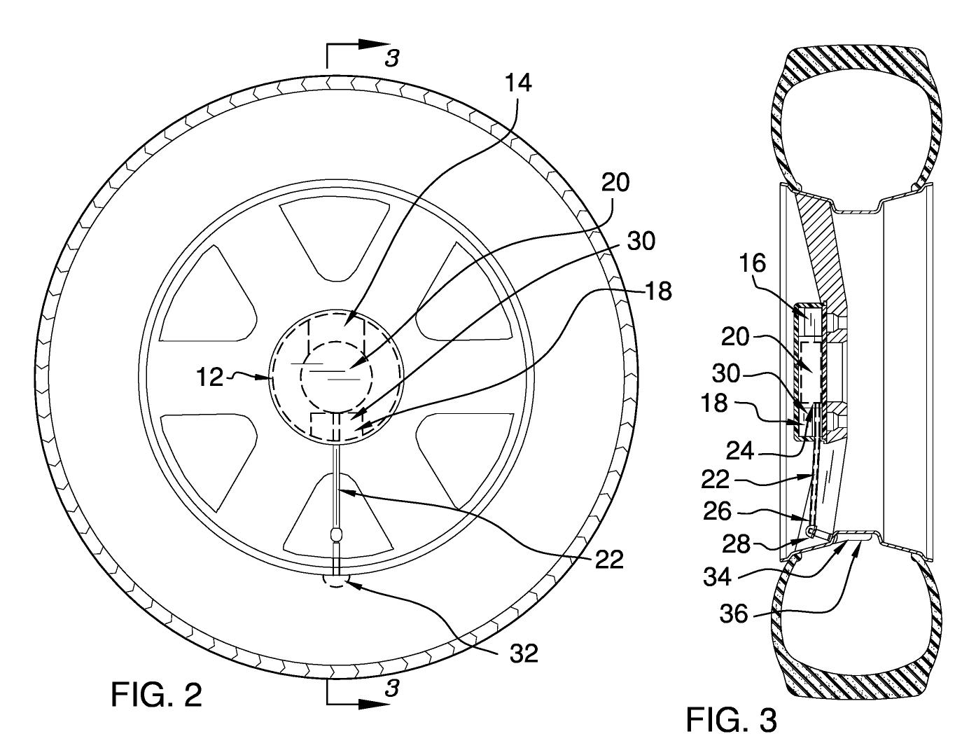

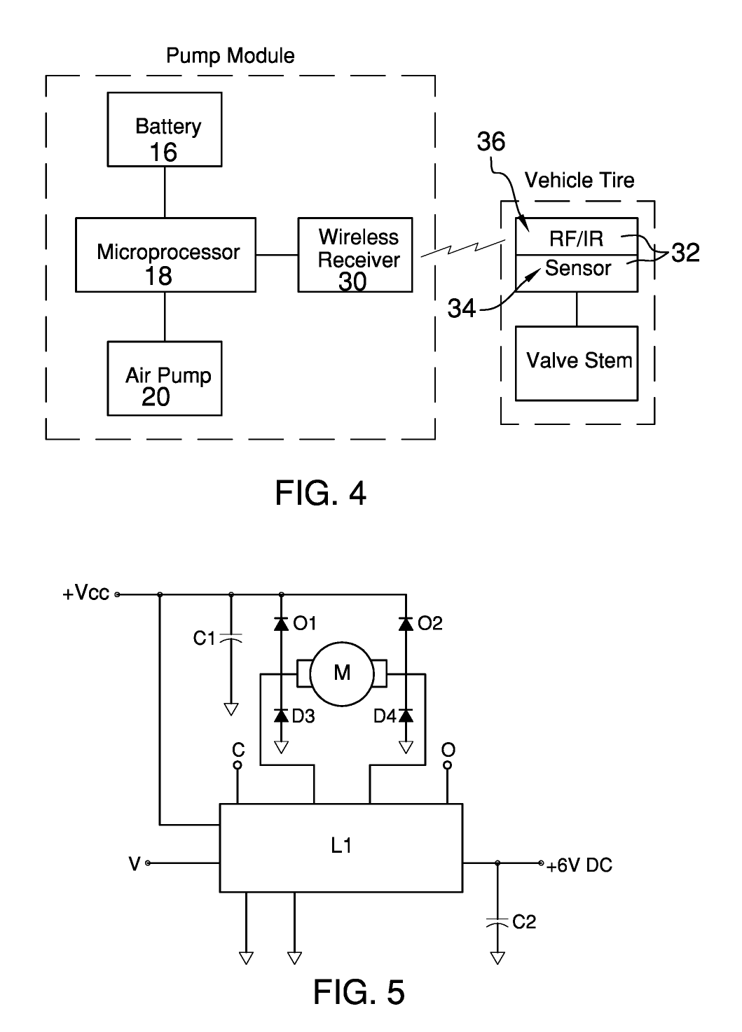

With reference now to the drawings, and in particular to FIGS. 1 through 5 thereof, a new monitoring and adjustment device embodying the principles and concepts of an embodiment of the disclosure and generally designated by the reference numeral 10 will be described.

As best illustrated in FIGS. 1 through 5, the pressure monitoring and adjustment device 10 generally comprises a housing 12 configured to couple to a rim of a wheel. Preferably, the housing 12 is configured to mount to the hub of a rim of a wheel, such that the housing 12 is centrally positioned in the wheel. Also preferably, the housing 12 is substantially disc shaped.

A power module 14 is coupled to and positioned in the housing 12. The power module 14 comprises at least one battery 16. Preferably, the battery 16 is rechargeable.

A microprocessor 18 is coupled to and positioned in the housing 12. The microprocessor 18 is operationally coupled to the power module 14.

An air pump 20 is coupled to and positioned in the housing 12. The air pump 20 is operationally coupled to the microprocessor 18. The air pump 20 has an outflow tube 22 fluidically connected to a stem valve of the wheel. The outflow tube 22 has a first end 24 that is fluidically coupled to the air pump 20. The outflow tube 22 has a second end 26 that comprises a connector 28. The connector 28 is configured to couple to the stem valve.

A receiver 30 is coupled to and positioned in the housing 12. The receiver 30 is operationally coupled to the microprocessor 18. The receiver 30 is radio frequency enabled. Alternatively, the receiver 30 is infrared light enabled. Preferably, the receiver 30 is both radio frequency and infrared light enabled.

A sensor unit 32 is coupled to the rim of the wheel and positioned in the internal space defined by the rim and a tire mounted to the rim. The sensor unit 32 is configured for wireless transmission of pressure measurements. More specifically, the sensor unit 32 comprises a pressure detector 34 and a transmitter 36. The transmitter 36 is operationally coupled to the pressure detector 34. The transmitter 36 is wirelessly coupled to the receiver 30. The sensor unit 32 may comprise a vehicle manufacturer installed Tire Pressure Monitoring Sensor. Alternatively, the sensor unit 32 may comprise an after-market Tire Pressure Monitoring Sensor.

In use, the sensor unit 32 is configured to measure pressure and positioned to send pressure readings to the receiver 30. The microprocessor 18 is positioned to respond to pressure readings relayed from the receiver 30 to motivate the air pump 20 to send air via the outflow tube 22 through the stem valve.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressure monitoring and adjustment device comprising:
a housing configured to couple to a rim of a wheel;
a power module coupled to and positioned in said housing;
a microprocessor coupled to and positioned in said housing, said microprocessor being operationally coupled to said power module;
an air pump coupled to and positioned in said housing, said air pump being operationally coupled to said microprocessor, said air pump having an outflow tube fluidically connected to a stem valve of the wheel;
a receiver coupled to and positioned in said housing, said receiver being operationally coupled to said microprocessor;
a sensor unit coupled to the rim of the wheel and positioned in the internal space defined by the rim and a tire mounted to the rim, said sensor unit being configured for wireless transmission of pressure measurements; and
wherein said sensor unit is configured to measure pressure and positioned to send pressure readings to said receiver, wherein said microprocessor is positioned to respond to pressure readings relayed from said receiver to motivate said air pump to send air via said outflow tube through the stem valve.

2. The device of claim 1, further including said housing being configured to mount to the hub of a rim of a wheel, such that said housing is centrally positioned in the wheel.

3. The device of claim 1, further including said housing being substantially disc shaped.

4. The device of claim 1, further including said power module comprising at least one battery.

5. The device of claim 4, further including said battery being rechargeable.

6. The device of claim 1, further including said outflow tube having a first end fluidically coupled to said air pump, said outflow tube having a second end comprising a connector, said connector being configured to couple to the stem valve.

7. The device of claim 1, further including said sensor unit comprising:
a pressure detector; and
a transmitter, said transmitter being operationally coupled to said pressure detector, said transmitter being wirelessly coupled to said receiver.

8. The device of claim 1, further including said sensor unit comprising a vehicle manufacturer installed tire pressure monitoring sensor.

9. The device of claim 1, further including said sensor unit comprising an after-market tire pressure monitoring sensor.

10. The device of claim 1, further including said receiver being radio frequency enabled.

11. The device of claim 1, further including said receiver being infrared light enabled.

12. The device of claim 1, further including said receiver being radio frequency and infrared light enabled.

13. A pressure monitoring and adjustment device comprising:
a housing configured to couple to a rim of a wheel, said housing being configured to mount to the hub of a rim of a wheel, such that said housing is centrally positioned in the wheel, said housing being substantially disc shaped;
a power module coupled to and positioned in said housing, said power module comprising at least one battery, said battery being rechargeable;
a microprocessor coupled to and positioned in said housing, said microprocessor being operationally coupled to said power module;
an air pump coupled to and positioned in said housing, said air pump being operationally coupled to said microprocessor, said air pump having an outflow tube fluidically connected to a stem valve of the wheel, said outflow tube having a first end fluidically coupled to said air pump, said outflow tube having a second end comprising a connector, said connector being configured to couple to the stem valve;
a receiver coupled to and positioned in said housing, said receiver being operationally coupled to said microprocessor, said receiver being radio frequency enabled;
a sensor unit coupled to the rim of the wheel and positioned in the internal space defined by the rim and a tire mounted to the rim, said sensor unit being configured for wireless transmission of pressure measurements, said sensor unit comprising:
a pressure detector, and
a transmitter, said transmitter being operationally coupled to said pressure detector, said transmitter being wirelessly coupled to said receiver;
said sensor unit comprising a vehicle manufacturer installed tire pressure monitoring sensor; and
wherein said sensor unit is configured to measure pressure and positioned to send pressure readings to said receiver, wherein said microprocessor is positioned to respond to pressure readings relayed from said receiver to motivate said air pump to send air via said outflow tube through the stem valve.

14. The device of claim 13, further including said receiver being infrared light enabled.

15. The device of claim 13, further including said receiver being radio frequency and infrared light enabled.

16. The device of claim 13, further including said sensor unit comprising an after-market tire pressure monitoring sensor.
